(19) United States
(12) Patent Application Publication
(10) Pub. No.: US 2025/0183335 A1
(43) Pub. Date: Jun. 5, 2025

(54) FUEL CELL SYSTEM

(71) Applicants: HYUNDAI MOTOR COMPANY, Seoul (KR); KIA CORPORATION, Seoul (KR)

(72) Inventors: Ju Yong Lee, Hwaseong-si (KR); Sung Hun Kim, Hwaseong-si (KR); Byeong Seung Lee, Hwaseong-si (KR); Ho Kyo Jung, Hwaseong-si (KR)

(73) Assignees: HYUNDAI MOTOR COMPANY, Seoul (KR); KIA CORPORATION, Seoul (KR)

(21) Appl. No.: 18/888,636

(22) Filed: Sep. 18, 2024

(30) Foreign Application Priority Data
Dec. 4, 2023 (KR) 10-2023-0173609

(51) Int. Cl. H01M 8/04119; B60L 50/72; H01M 8/04746; H01M 8/2484

(52) U.S. Cl. CPC H01M 8/04126; H01M 8/04753; H01M 8/2484; B60L 50/72; H01M 2250/20

(57) ABSTRACT

A fuel cell system includes a fuel cell stack, a humidifier configured to humidify air to be supplied to the fuel cell stack, and an air control valve. The air control valve has one end connected to the fuel cell stack and the other end connected directly to the humidifier. The air control valve is configured to control air that enters or exits the fuel cell stack, thereby obtaining advantageous effects of simplifying a structure and improving spatial utilization and a degree of design freedom.

### CROSS-REFERENCE TO RELATED APPLICATION

This application claims priority to and the benefit of Korean Patent Application No. 10-2023-0173609 filed in the Korean Intellectual Property Office on Dec. 4, 2023, the entire contents of which are incorporated herein by reference.

### TECHNICAL FIELD

The present disclosure relates to a fuel cell system, and more particularly, to a fuel cell system having a simplified structure and improving spatial utilization and a degree of design freedom.

### BACKGROUND ART

A fuel cell electric vehicle (FCEV) produces electrical energy from an electrochemical reaction between oxygen and hydrogen in a fuel cell stack and travels by operating a motor.

The fuel cell electric vehicle may continuously generate electricity, regardless of a capacity of a battery, by being supplied with fuel (hydrogen) and air from the outside. The vehicle thus has high efficiency and emits almost no contaminants. By virtue of these advantages, continuous research and development is being conducted on the fuel cell electric vehicle.

In general, the fuel cell electric vehicle may include a fuel cell stack configured to generate electricity by means of an oxidation-reduction reaction between hydrogen and oxygen, a fuel supply device configured to supply fuel (hydrogen) to the fuel cell stack, and an air supply device configured to supply the fuel cell stack with reaction air (oxygen) as an oxidant required for an electrochemical reaction.

An electrolyte membrane of a membrane electrode assembly needs to be maintained at a predetermined humidity or higher in order to normally operate the fuel cell stack. Thus, inflow gas introduced into the fuel cell stack may be humidified by a humidifier before being introduced into the fuel cell stack.

Recently, a method has been proposed of humidifying inflow gas (dry air), which passes through the humidifier, by using moist air discharged from the fuel cell stack.

In addition, a fuel cell electric vehicle is provided with an air control valve configured to control air to be introduced into the fuel cell stack, i.e., via the humidifier, and air to be discharged from the fuel cell stack, i.e., to the humidifier.

Meanwhile, in order to improve spatial utilization and a degree of design freedom of the fuel cell electric vehicle, it is necessary to minimize a space (distance) between the fuel cell stack and the humidifier.

However, in the related art, because the air control valve and the fuel cell stack are connected by a separate tube (hose), there is a problem in that it is difficult to reduce the distance between the fuel cell stack and the humidifier to a certain degree or more. As a result, a degree of design freedom and spatial utilization may be deteriorated.

In particular, because a curved tube (e.g., an S-shaped tube) needs to be provided to connect the air control valve and the humidifier in the related art as described above, it is necessary to ensure a space, which has a height that allows a curvature of the curved tube, that allows the curved tube to be disposed between the fuel cell stack and the humidifier. As a result, there is a problem in that it is difficult to reduce the distance between the fuel cell stack and the humidifier to a certain degree or more. As a result, a degree of design freedom and spatial utilization may be deteriorated.

Moreover, because the tube for connecting the air control valve and the humidifier is formed in a curved shape in the related art, there is a problem in that a structure and a manufacturing process of the tube are complicated. There is also a disadvantage in terms of costs, a differential pressure of the humidifier is increased due to the curvature of the tube, and energy efficiency deteriorates (i.e., electric power consumption increases).

Therefore, recently, various types of research have been conducted to minimize the space between the fuel cell stack and the humidifier and improve spatial utilization and a degree of design freedom. However, the research results are still insufficient. Accordingly, there is a need for further development of a humidifier for a fuel cell, which is capable of minimizing the space between the fuel cell stack and the humidifier and thus improving spatial utilization and a degree of design freedom.

### SUMMARY

The present disclosure has been made in an effort to provide a fuel cell system that may have a simple structure and improve a degree of design freedom and spatial utilization.

In particular, the present disclosure has been made in an effort to simplify a structure for connecting an air control valve and a humidifier and to minimize a space between a fuel cell stack and the humidifier.

Among other things, the present disclosure has been made in an effort to connect the air control valve directly to the humidifier without using a separate tube for connecting the air control valve and the humidifier.

The present disclosure has also been made in an effort to simplify a manufacturing process and reduce costs.

The present disclosure has also been made in an effort to minimize reduction or deterioration in energy efficiency caused by an increase in differential pressure in the humidifier and to improve the performance and operational efficiency of the fuel cell stack.

The objects to be achieved by the embodiments are not limited to the above-mentioned objects Other objects or effects may be understood from the solutions or embodiments described below.

In order to achieve the above-mentioned objects, the present disclosure provides a fuel cell system including: a fuel cell stack; a humidifier configured to humidify air to be supplied to the fuel cell stack; and an air control valve having one end connected to the fuel cell stack and another end connected directly to the humidifier. The air control valve is configured to control air that enters or exits the fuel cell stack.

This is to simplify a structure of the fuel cell system and to improve a degree of design freedom and spatial utilization.

In other words, because a curved tube (e.g., an S-shaped tube) needs to be provided to connect the air control valve and the humidifier in the related art as described above, it is necessary to ensure a space, which has a height that allows a curvature of the curved tube, that allows the curved tube to be disposed between the fuel cell stack and the humidifier. As a result, there is a problem in that it is difficult to reduce the distance between the fuel cell stack and the humidifier to a certain degree or more. Also a degree of design freedom and spatial utilization may be deteriorated. Moreover, because the tube for connecting the air control valve and the humidifier is formed in a curved shape in the related art, there is a problem in that a structure and a manufacturing process are complicated. Also, there is a disadvantage in terms of costs, a differential pressure of the humidifier is increased due to the curvature of the tube, and energy efficiency deteriorates, i.e., electric power consumption increases.

In contrast, in an embodiment of the present disclosure, the air control valve, which controls air that enters or exits the fuel cell stack, is connected directly to the humidifier. Therefore, it is possible to obtain an advantageous effect of simplifying the structure for connecting the air control valve and the humidifier and minimizing the space between the fuel cell stack and the humidifier.

Among other things, according to an embodiment of the present disclosure, the air control valve is connected directly to the humidifier without using a separate tube for connecting the air control valve and the humidifier. Thus, it is not necessary to provide a space in which the separate tube needs to be disposed between the air control valve and the humidifier. Therefore, it is possible to obtain advantageous effects of minimizing the distance, i.e., height, between the air control valve and the humidifier and improving the degree of design freedom and spatial utilization.

In addition, according to an embodiment of the present disclosure, a separate tube for connecting the air control valve and the humidifier need not be provided. Therefore, it is possible to obtain advantageous effects of minimizing an increase in differential pressure in the humidifier caused by the structural properties of the tube (e.g., a curvature of the tube) and reducing the manufacturing costs and weight.

The humidifier may have various structures capable of humidifying dry air by using air (moist air) discharged from the fuel cell stack.

According to an embodiment of the present disclosure, the humidifier may include a humidifier housing having a humidification part, a first humidifier port, and a second humidifier port. The first humidifier port may be provided at one end of the humidifier housing and configured to allow the air having passed through the humidification part to be discharged through the first humidifier port. The second humidifier port may be provided in the humidifier housing, may be disposed adjacent to the first humidifier port, and may be configured to allow moist air discharged from the fuel cell stack to enter the second humidifier port. The air control valve may be seated on the humidifier housing and connected directly to the first humidifier port and the second humidifier port.

The shape and the structure of the humidifier housing may be variously changed in accordance with required conditions and design specifications.

According to an embodiment of the present disclosure, the humidifier housing may include a housing main body, a first housing cap connected to one end of the housing main body, and a second housing cap connected to the other end of the housing main body.

According to an embodiment of the present disclosure, the humidifier housing may include a first space configured to accommodate the humidification part and communicate with the first humidifier port and may include a second space separated from the first space and configured to communicate with the second humidifier port.

According to the embodiment of the present disclosure, the second humidifier port and the first humidifier port may be disposed in parallel with each other in a direction perpendicular to the longitudinal direction of the humidifier housing.

The air control valve may have various structures capable of controlling air that enters or exits the fuel cell stack.

According to an embodiment of the present disclosure, the air control valve may include: a valve housing having a first valve port corresponding to the first humidifier port and a second valve port corresponding to the second humidifier port; a first valve disc configured to selectively open or close the first valve port; and a second valve disc configured to selectively open or close the second valve port.

The first valve disc and the second valve disc may have various structures capable of opening or closing the first valve port and the second valve port.

According to an embodiment of the present disclosure, the fuel cell system may include a rotary shaft rotatably provided on the valve housing. The first and second valve discs may be configured to rotate about the rotary shaft from a first position at which the first and second valve discs close the first and second valve ports to a second position at which the first and second valve discs open the first and second valve ports.

According to an embodiment of the present disclosure, the fuel cell system may include a bypass flow path provided in the humidifier housing and configured to connect the first humidifier port and the second humidifier port so that the first humidifier port and the second humidifier port communicate with each other. The bypass flow path may be configured to allow the air introduced into the first humidifier port to selectively flow to the second humidifier port.

According to an embodiment of the present disclosure, inlet and outlet ends of the bypass flow path may be connected to and communicate with lateral sides of the first and second humidifier ports based on a longitudinal direction of the humidifier housing.

As described above, in an embodiment of the present disclosure, the bypass flow path may be provided at the lateral sides of the first and second humidifier ports and disposed in a horizontal direction (e.g., the longitudinal direction of the humidifier housing) instead of the upward/downward direction. In other words, the bypass flow path may be provided in a dead space (dead zone) of the lateral side of the humidifier so as not to increase the thickness of the humidifier. Therefore, it is possible to obtain an advantageous effect of minimizing an increase in vertical heights of the humidifier and the air control valve, which may be caused when the bypass flow path is provided.

According to an embodiment of the present disclosure, the bypass flow path may be closed by the first and second valve discs when the first and second valve discs rotate from the first position to the second position.

As described above, in an embodiment of the present disclosure, the bypass flow path may be opened or closed by the first and second valve discs configured to open or close the first and second valve ports. Thus, a separate opening/closing member for opening or closing the bypass flow path need not be additionally provided. Therefore, it is possible to obtain advantageous effects of simplifying the structure and improving the spatial utilization and degree of design freedom.

According to an embodiment of the present disclosure, the fuel cell system may include a manifold block provided at an end of the fuel cell stack and having a first manifold flow path corresponding to the first valve port and a second manifold flow path corresponding to the second valve port. The air control valve may be connected to the manifold block and communicates with the first manifold flow path and the second manifold flow path.

According to an embodiment of the present disclosure, the first and second manifold flow paths may be defined to have straight sections in an upward/downward direction. Also, the air control valve may be connected to an end of the first manifold flow path and an end of the second manifold flow path based on the upward/downward direction.

As described above, in an embodiment of the present disclosure, the air control valve may be connected to the ends of the first and second manifold flow paths defined to have the straight sections in the upward/downward direction. Thus, the first valve port and the first manifold flow path may be connected in a continuous straight shape without being bent and the second valve port and the second manifold flow path may be connected in a continuous straight shape without being bent. Therefore, it is possible to implement a smaller thickness of the manifold block in the longitudinal direction of the humidifier (the direction in which the fuel cells are stacked).

In particular, in an embodiment of the present disclosure, the air control valve may be connected to the ends of the manifold flow paths (e.g., the first manifold flow path and the second manifold flow path) based on the upward/downward direction. Therefore, it is possible to reduce the number of curved portions of the manifold flow path, and particularly, a connection portion between the valve port and the manifold flow path is not bent. It is also possible to form an overall gentle curvature of the manifold flow path without increasing the thickness of the manifold block.

According to an embodiment of the present disclosure, the fuel cell system may include a gas-liquid separator provided between the first valve port and the first manifold flow path.

### BRIEF DESCRIPTION OF THE DRAWINGS

FIG. 1 is a view of a fuel cell system according to an embodiment of the present disclosure.

FIGS. 2 and 3 are views of an air control valve of a fuel cell system according to an embodiment of the present disclosure.

FIG. 4 is a top plan view of a humidifier of a fuel cell system according to an embodiment of the present disclosure.

FIG. 5 is a cross-sectional view taken along line ‘I-I’ of the humidifier in FIG. 4.

FIG. 6 is a view of a first humidifier port and a first valve port of a fuel cell system according to an embodiment of the present disclosure.

FIG. 7 is a cross-sectional view taken along line ‘II-II’ of the humidifier in FIG. 4.

FIG. 8 is a view of a second humidifier port and a second valve port of a fuel cell system according to an embodiment of the present disclosure.

FIGS. 9 and 10 are views of a bypass flow path of a fuel cell system according to an embodiment of the present disclosure.

FIGS. 11 and 12 are views of a manifold block of a fuel cell system according to an embodiment of the present disclosure.

FIG. 13 is a view of a gas-liquid separator of a fuel cell system according to an embodiment of the present disclosure.

### DETAILED DESCRIPTION

Hereinafter, embodiments of the present disclosure are described in detail with reference to the accompanying drawings.

However, the technical spirit of the present disclosure is not limited to the embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in describing the embodiments of the present disclosure may be construed as having the meanings that may be commonly understood by a person with ordinary skill in the art to which the present disclosure pertains. The meanings of the commonly used terms such as the terms defined in dictionaries may be interpreted consistent with such definitions, but also in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include each individually as well as one or more of all combinations that can be made by combining A, B, and C.

In addition, the terms such as first, second, A, B, (a), and (b) may be used to describe constituent elements of the embodiments of the present disclosure.

These terms are used only for the purpose of distinguishing one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

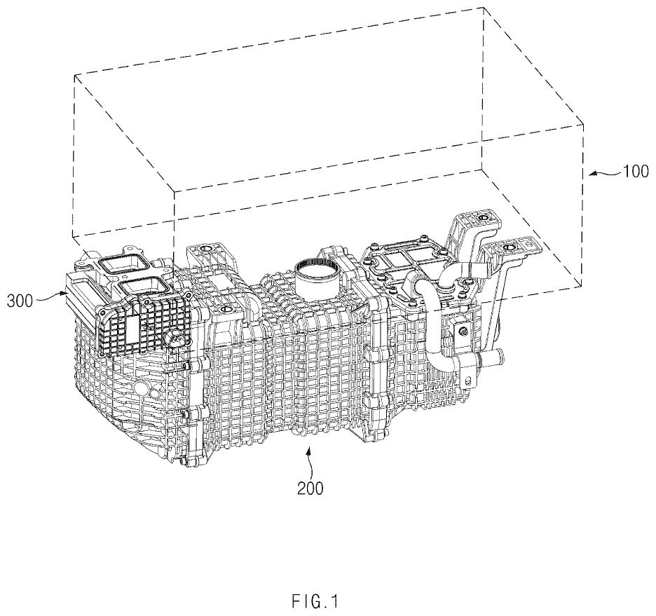

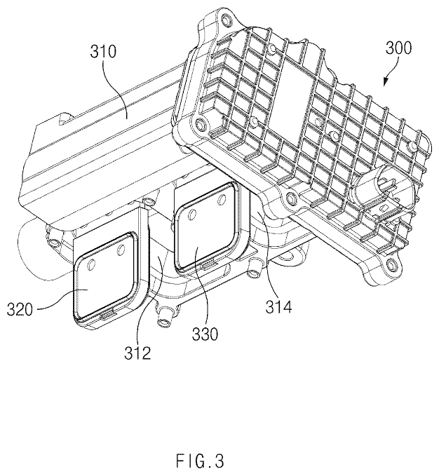

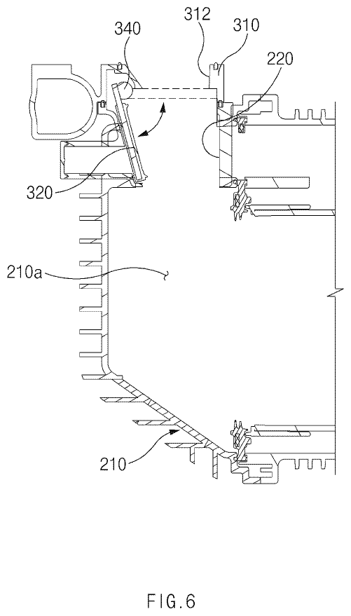

With reference to FIGS. 1-13, a fuel cell system 10 according to an embodiment of the present disclosure includes a fuel cell stack 100, a humidifier 200, and an air control valve 300. The humidifier 200 is configured to humidify air to be supplied to the fuel cell stack 100. The air control valve 300 has one end connected to the fuel cell stack 100 and the other end connected directly to the humidifier 200. The air control valve 300 is also configured to control air that enters or exits the fuel cell stack 100.

For reference, the fuel cell system 10 according to an embodiment of the present disclosure may be applied to various vehicles (e.g., passenger vehicles or commercial vehicles), ships, vehicles in aerospace fields, and the like to which the fuel cell stack 100 may be applied. The present disclosure is not restricted or limited by the type and properties of an object (vehicle) to which the fuel cell system 10 is applied.

The fuel cell stack 100 refers to a kind of power generation device that generates electrical energy through a chemical reaction of fuel (e.g., hydrogen). The fuel cell stack may be configured by stacking several tens or hundreds of fuel cells (unit cells) in series.

The fuel cell stack 100 may have various structures capable of producing electricity by means of an oxidation-reduction reaction between fuel (e.g., hydrogen) and an oxidant (e.g., air).

For example, the fuel cell stack 100 in one embodiment includes a membrane electrode assembly (MEA) (not illustrated) having catalyst electrode layers in which electrochemical reactions occur and which are attached to two opposite sides of an electrolyte membrane through which hydrogen ions move. The fuel cell stack 100 also includes a gas diffusion layer (GDL) (not illustrated) configured to uniformly distribute reactant gases and transfer generated electrical energy. The fuel cells tack 100 also includes a gasket (not illustrated) and a fastener (not illustrated) configured to maintain leakproof sealability for the reactant gases and a coolant and maintain an appropriate fastening pressure. The fuel cell stack 100 also includes a separator (bipolar plate) (not illustrated) configured to move the reactant gases and the coolant.

More specifically, in the fuel cell stack 100, hydrogen, which is fuel, and air (oxygen), which is an oxidant, are supplied to an anode and a cathode of the membrane electrode assembly, respectively, through flow paths in the separators. Thus, the hydrogen is supplied to the anode and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane. At the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires and the electric current is generated as a result of the flow of the electrons.

The electrolyte membrane of the membrane electrode assembly should be maintained at a predetermined humidity or higher so that the fuel cell stack 100 normally operates.

To this end, air supplied along an air supply line (not illustrated) may pass through the humidifier 200 and air to be supplied to the fuel cell stack 100 along the air supply line may be humidified while passing through the humidifier 200. In this case, the humidification of air is defined as a process of increasing the humidity of the air.

The humidifier 200 is configured to humidify air (dry air) to be supplied to the fuel cell stack 100 by using air (moist air) discharged from the fuel cell stack 100.

The humidifier 200 may have various structures capable of humidifying the dry air by using the air (moist air) discharged from the fuel cell stack 100. The present disclosure is not restricted or limited by the structure of the humidifier 200.

According to an embodiment of the present disclosure, the humidifier 200 may include a humidifier housing 210 having a humidification part 202. The humidifier 200 may also include a first humidifier port 220 provided at one end of the humidifier housing 210 and configured to discharge the air having passed through the humidification part 202 (discharge the air to the fuel cell stack). The humidifier 200 may also include a second humidifier port 230 provided in the humidifier housing 210, disposed adjacent to the first humidifier port 220, and configured to allow the moist air, which is discharged from the fuel cell stack 100, to enter the second humidifier port 230. The air control valve 300 may be seated on the humidifier housing 210 and connected directly to the first humidifier port 220 and the second humidifier port 230.

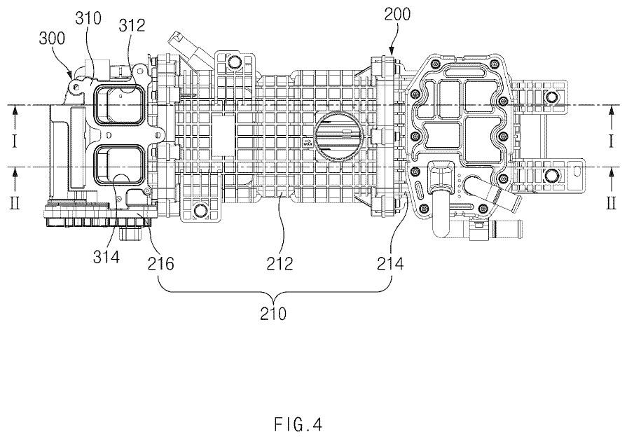

With reference to FIGS. 4-8, the humidifier housing 210 is provided to have a predetermined accommodation space therein.

The humidifier housing 210 may be variously changed in shape and structure in accordance with required conditions and design specifications. The present disclosure is not restricted or limited by the shape and structure of the humidifier housing 210.

For example, the humidifier housing 210 may include a housing main body 212, a first housing cap 214 connected to one end of the housing main body 212, and a second housing cap 216 connected to the other end of the housing main body 212.

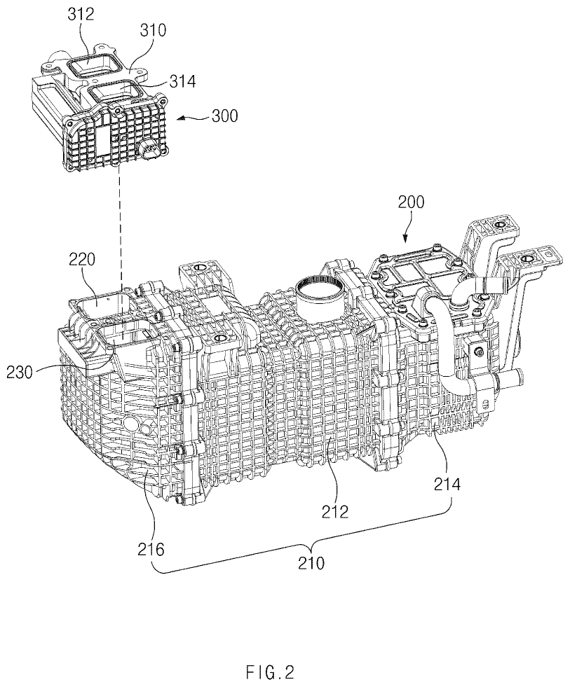

For example, the housing main body 212 may be provided in the form of an approximately quadrangular box having the accommodation space therein. The first housing cap 214 may be connected to a right end (based on FIG. 2) of the housing main body 212. The second housing cap 216 may be connected to a left end (based on FIG. 2) of the housing main body 212.

According to another embodiment of the present disclosure, the first housing cap and the second housing cap may be provided at an upper or lower end of the housing main body.

The first housing cap 214 may be provided with an air supply port (not illustrated) through which air is introduced (supplied). The second housing cap 216 may be provided with the first humidifier port 220, through which the air (humidified air) having passed through the humidification part 202 is discharged, and with the second humidifier port 230 through which moist air discharged from the fuel cell stack 100 is supplied. The housing main body 212 may be provided with a moist air discharge port (not illustrated) through which the moist air is discharged.

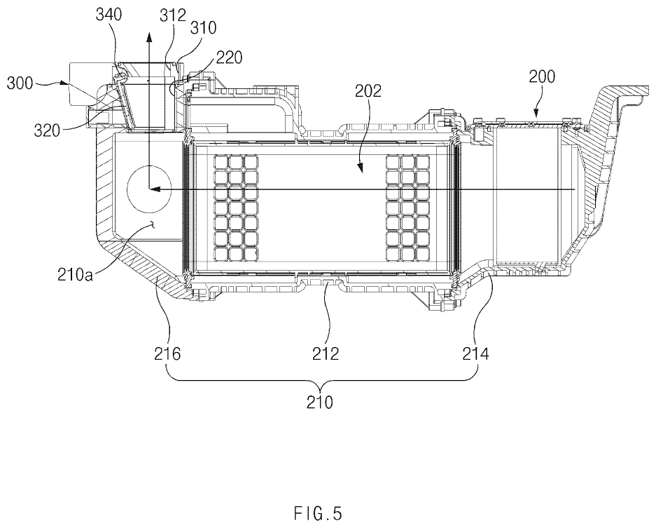

With reference to FIG. 5, the air introduced through the air supply port of the first housing cap 214 may be humidified by the moist air while passing through the humidification part 202 provided in a first space 210a defined in the housing main body 212. The air (humidified air), which is discharged through the first humidifier port 220 of the second housing cap 216, may be supplied to the fuel cell stack 100.

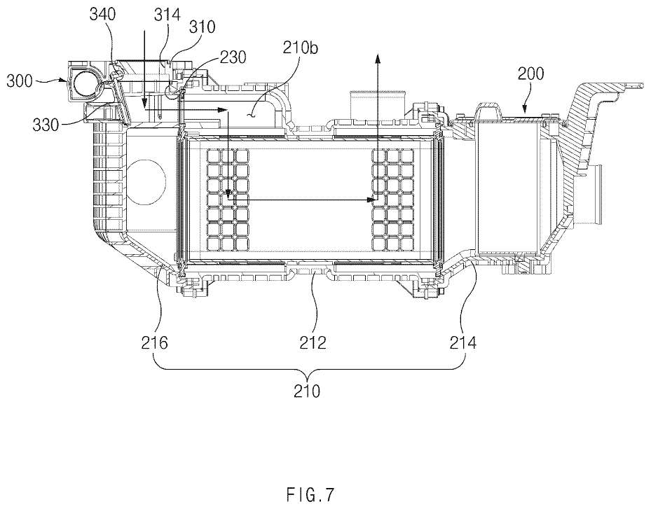

Further, with reference to FIG. 7, the moist air (or produced water) discharged from the fuel cell stack 100 may be supplied to the second humidifier port 230 of the first housing cap 214 to humidify the air, which passes through the humidification part 202, in the first space 210a. Then the moist air may be discharged to the outside of the humidifier 200 through the moist air discharge port.

In the humidifier housing 210, the first space 210a is provided and communicates with the first humidifier port 220 and a second space 210b is provided and is independently sealed (separated) from the first space 210a and communicates with the second humidifier port 230.

For reference, in an embodiment of the present disclosure, the first space 210a may be defined as a space sealed independently of the second space 210b and provided in the humidifier housing 210 so as to communicate with the humidification part 202 and allow the humidified air to flow therethrough.

In addition, in an embodiment of the present disclosure, the second space 210b may be defined as a space in which the moist air discharged from the fuel cell stack 100 flows, i.e., a space or region in which the humidification part 202 is disposed.

The dividing (sealed) structure between the first space 210a and the second space 210b may be variously changed in accordance with required conditions and design specifications.

For example, the humidifier 200 may include a partition part (not illustrated) that divides an internal space of the humidifier housing 210 into the first space 210a and the second space 210b.

The partition part may have various structures capable of dividing the internal space of the humidifier housing 210 into the first space 210a and the second space 210b. The present disclosure is not restricted or limited by the structure of the partition part.

The humidification part 202 is provided in the first space 210a to humidify the inflow gas by using the moist air supplied into the humidifier housing 210.

The humidification part 202 may have various structures capable of humidifying the air by using the moist air. The present disclosure is not restricted or limited by the structure of the humidification part 202.

For example, the humidification part 202 may include a cartridge casing (not illustrated) provided in the humidifier housing 210. The cartridge casing may have, at one side thereof, a first through portion (not illustrated) through which the moist air is introduced and may have, at the other side thereof, a second through portion (not illustrated) through which the moist air is discharged. The cartridge casing may also have a humidification membrane (not illustrated) provided in the cartridge casing and configured to allow air to move along the humidification membrane.

The cartridge casing may have various structures having therein an accommodation space. The present disclosure is not limited or restricted by the structure of the cartridge casing.

For reference, the number of cartridge casings and the arrangement of the cartridge casing(s) may be variously changed in accordance with required conditions and design specifications. For example, only one cartridge casing may be provided in the humidifier housing 210. According to another embodiment of the present disclosure, a plurality of cartridge casings may be provided in the housing.

The humidification membrane is provided in the cartridge casing and configured such that the air moves along the inside of the humidification membrane.

For example, the humidification membrane is provided in the form of a tubular hollow fiber membrane along which air may move. One end, i.e., an inlet end, and the other end, i.e., an outlet end, of the humidification membrane may be fixed in the cartridge casing by a potting material.

For reference, because the humidification membrane is provided in the form of a hollow fiber membrane, the moisture (e.g., the moisture in the moist air) supplied into the cartridge casing may penetrate into the humidification membrane from the outside of the humidification membrane and then be transferred to the air. However, the air cannot penetrate the humidification membrane from the inside of the humidification membrane to the outside of the humidification membrane.

With the above-mentioned configuration, the moist air, which is supplied to the second space 210b through the second humidifier port 230, may be supplied into the cartridge casing through the first through portion. Also, the moist air, which is supplied into the cartridge casing, may flow along a periphery of the humidification membrane and humidify the air moving along the humidification membrane. Thereafter, the moist air, which is discharged to the outside of the cartridge casing through the second through portion, may be discharged to the outside of the humidifier housing 210 through the moist air discharge port.

For reference, in an embodiment of the present disclosure described and illustrated above, one example has been described in which the humidification membrane is disposed in the cartridge casing. However, according to another embodiment of the present disclosure, the humidification membrane may be directly disposed in the first space without separately providing the cartridge casing.

The second humidifier port 230 is provided to supply the moist air, which is discharged from the fuel cell stack 100, into the humidifier housing 210.

More specifically, the second humidifier port 230 may be provided at one end of the humidifier housing 210 and communicate with the second space 210b. The moist air discharged from the fuel cell stack 100 may be supplied to the second space 210b (the periphery of the humidification membrane) along the second humidifier port 230.

The first humidifier port 220 is provided to discharge the air (humidified air humidified while passing through the humidification part), which moves along the first space 210a, to the fuel cell stack 100.

More specifically, the first humidifier port 220 may communicate with the first space 210a and be connected to one end of the humidifier housing 210 so as to be disposed in parallel with the second humidifier port 230. The air having passed through the humidification part 202 may be discharged to the fuel cell stack 100 through the first humidifier port 220.

In particular, the second humidifier port 230 and the first humidifier port 220 may be disposed in parallel with each other in a direction (an upward/downward direction based on FIG. 2) perpendicular to a longitudinal direction of the humidifier housing 210.

With reference to FIGS. 2-10, the air control valve 300 is configured to control the air that enters or exits the fuel cell stack 100. One end of the air control valve 300 is connected to the fuel cell stack 100 and the other end of the air control valve 300 is connected directly to the humidifier 200.

In this case, the air, which enters or exits the fuel cell stack 100, is defined as including both the air introduced into the fuel cell stack 100 and the moist air discharged from the fuel cell stack 100.

In addition, in an embodiment of the present disclosure, the configuration in which the air control valve 300 is connected directly to the humidifier 200 may be understood as a configuration in which the air control valve 300 is connected directly to the humidifier 200 without using a separate tube or hose.

The air control valve 300 may have various structures capable of controlling the air that enters or exits the fuel cell stack 100. The present disclosure is not restricted or limited by the type and structure of the air control valve 300.

According to an embodiment of the present disclosure, the air control valve 300 may include a valve housing 310 having a first valve port 312 corresponding to the first humidifier port 220 and a second valve port 314 corresponding to the second humidifier port 230. The air control valve may also include a first valve disc 320 configured to selectively open or close the first valve port 312 and a second valve disc 330 configured to selectively open or close the second valve port 314.

The valve housing 310 may have various structures having the first valve port 312 and the second valve port 314. The present disclosure is not restricted or limited by the structure and shape of the valve housing 310.

For example, the valve housing 310 may be provided in the form of an approximately quadrangular box. In the valve housing 310, the first valve port 312, which corresponds to the first humidifier port 220, and the second valve port 314, which corresponds to the second humidifier port 230, may be spatially separated, i.e., partitioned.

For example, the first valve port 312 and the second valve port 314 may each have an approximately quadrangular cross-sectional shape. According to another embodiment of the present disclosure, the first valve port and the second valve port may each have a circular cross-sectional shape or other cross-sectional shapes.

One end of the first valve port 312 may be disposed between the humidifier 200 and the fuel cell stack 100 and communicate with an air intake port (not illustrated) of the fuel cell stack 100. The other end of the first valve port 312 may communicate with the first humidifier port 220.

Likewise, one end of the second valve port 314 may be disposed between the humidifier 200 and the fuel cell stack 100 and communicate with an air discharge port (not illustrated) of the fuel cell stack 100. The other end of the second valve port 314 may communicate with the second humidifier port 230.

The first valve disc 320 is configured to selectively open or close the first valve port 312. The second valve disc 330 is configured to selectively open or close the second valve port 314.

In this case, the process of opening or closing the first valve port 312 and the second valve port 314 may be understood as including both a process of turning on or off a flow of air, which enters or exits the first valve port 312 and the second valve port 314, and a process of controlling a flow rate.

The first and second valve discs 320 and 330 may have various structures capable of opening or closing the first and second valve ports 312 and 314. The present disclosure is not restricted or limited by the structures of the first and second valve discs 320 and 330.

According to an embodiment of the present disclosure, the air control valve 300 may include a rotary shaft 340 rotatably provided on the valve housing 310. The first and second valve discs 320 and 330 may be configured to rotate about the rotary shaft 340 from a first position at which the first and second valve discs 320 and 330 close the first and second valve ports 312 and 314 to a second position at which the first and second valve discs 320 and 330 open the first and second valve ports 312 and 314.

For example, the first and second valve discs 320 and 330 may be provided in the form of approximately quadrangular plates corresponding to the first and second valve ports 312 and 314.

The rotary shaft 340 is rotatably provided at one side (e.g., an upper end) of the valve housing 310 and configured to be rotated by driving power of a driving source (not illustrated).

The rotary shaft 340 may have various structures rotatable on the valve housing 310. The present disclosure is not restricted or limited by the structure and shape of the rotary shaft 340.

For example, the rotary shaft 340 may be provided in the form of a straight rod having a circular cross-section.

A typical drive means capable of rotating the rotary shaft 340 may be used as the driving source. The present disclosure is not restricted or limited by types of driving sources or methods of operating the driving sources.

For example, a motor may be used as the driving source. According to another embodiment of the present disclosure, other drive means such as a pneumatic cylinder or a hydraulic cylinder may be used as the driving source.

The first valve disc 320 is integrally connected to the rotary shaft 340 and configured to open or close the first valve port 312 while rotating about the rotary shaft 340.

For example, the first valve disc 320 has a shape corresponding to a cross-sectional shape (e.g., a quadrangular cross-sectional shape) of the first valve port 312. According to another embodiment of the present disclosure, the first valve disc may have a shape different from the cross-sectional shape of the first valve port. The present disclosure is not restricted or limited by the shape and structure of the first valve disc.

The first valve disc 320 may be rotated in a hinged manner by the rotary shaft 340 rotated by the driving source. The first valve disc 320 may rotate from the first position (closed position) at which the first valve disc 320 closes the first valve port 312 to the second position (opened position) at which the first valve disc 320 opens the first valve port 312.

For reference, an operating angle of the first valve disc 320 may be variously changed in accordance with required conditions and design specifications. The present disclosure is not restricted or limited by the operating angle of the first valve disc 320.

For example, when the first valve disc 320 rotates about 75 degrees from the first position, the first valve disc 320 may be positioned at the second position. According to another embodiment of the present disclosure, the operating angle of the first valve disc may be defined to be smaller or larger than 75 degrees (e.g., 60 degrees, 90 degrees, or the like).

The second valve disc 330 is integrally connected to the rotary shaft 340 and configured to open or close the second valve port 314 while rotating about the rotary shaft 340.

For example, the second valve disc 330 has a shape corresponding to a cross-sectional shape (e.g., a quadrangular cross-sectional shape) of the second valve port 314. According to another embodiment of the present disclosure, the second valve disc may have a shape different from the cross-sectional shape of the second valve port. The present disclosure is not restricted or limited by the shape and structure of the second valve disc.

The second valve disc 330 may be rotated in a hinged manner by the rotary shaft 340 from the first position (closed position) at which the second valve disc 330 closes the second valve port 314 to the second position (opened position) at which the second valve disc 330 opens the second valve port 314.

For reference, an operating angle of the second valve disc 330 may be variously changed in accordance with required conditions and design specifications. The present disclosure is not restricted or limited by the operating angle of the second valve disc 330.

For example, when the second valve disc 330 rotates about 75 degrees from the first position, the second valve disc 330 may be positioned at the second position. According to another embodiment of the present disclosure, the operating angle of the second valve disc may be defined to be smaller or larger than 75 degrees (e.g., 60 degrees, 90 degrees, or the like).

In an embodiment of the present disclosure illustrated and described above, the example has been described in which the first valve disc 320 and the second valve disc 330 are simultaneously rotated by the single rotary shaft 340. However, according to another embodiment of the present disclosure, the first valve disc and the second valve disc may be configured to be independently or sequentially rotated by different rotary shafts.

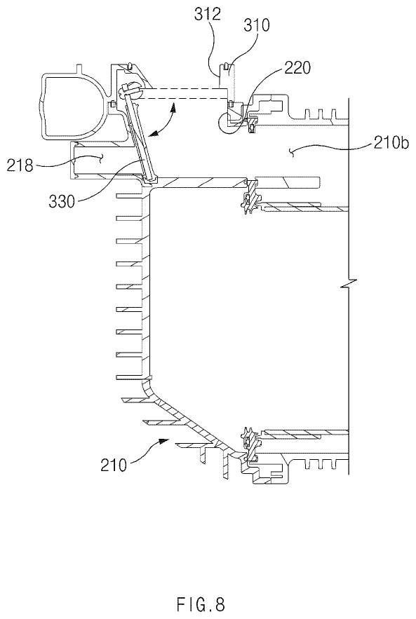

With reference to FIGS. 8-10, according to an embodiment of the present disclosure, the fuel cell system 10 may include a bypass flow path 218 provided in the humidifier housing 210 and configured to connect the first humidifier port 220 and the second humidifier port 230 so that the first humidifier port 220 and the second humidifier port 230 communicate with each other. The bypass flow path 218 is configured to allow the air (humidified air) introduced into the first humidifier port 220 to selectively flow to the second humidifier port 230.

In particular, inlet and outlet ends of the bypass flow path 218 may be connected to and communicate, respectively, with lateral sides of the first and second humidifier ports 220 and 230 based on the longitudinal direction of the humidifier housing 210.

For example, the bypass flow path 218 may be provided at a lateral side of an end of the humidifier housing 210 (an end of the second housing cap) based on the longitudinal direction and positioned below the air control valve 300.

As described above, in an embodiment of the present disclosure, the bypass flow path 218 is provided at the lateral sides of the first and second humidifier ports 220 and 230 and disposed in a horizontal direction (e.g., the longitudinal direction of the humidifier housing) instead of the upward/downward direction. In other words, the bypass flow path 218 is provided in a dead space (dead zone) of the lateral side of the humidifier 200 so as not to increase the thickness of the humidifier 200. Therefore, it is possible to obtain an advantageous effect of minimizing an increase in vertical heights of the humidifier 200 and the air control valve 300, which may be caused when the bypass flow path 218 is provided.

The bypass flow path 218 may have various structures capable of allowing the air introduced into the first humidifier port 220 to flow to the second humidifier port 230 in the horizontal direction. The present disclosure is not restricted or limited by the structure and shape of the bypass flow path 218.

For example, the bypass flow path 218 may have an approximately “U” shape. One end (i.e., an inlet end) of the bypass flow path 218 may communicate with the lateral side of the first humidifier port 220 and the other end (i.e., an outlet end) of the bypass flow path 218 may communicate with the lateral side of the second humidifier port 230.

According to an embodiment of the present disclosure, when the first valve disc 320 and the second valve disc 330 rotate from the first position to the second position, the bypass flow path 218 may be closed by the first valve disc 320 and the second valve disc 330.

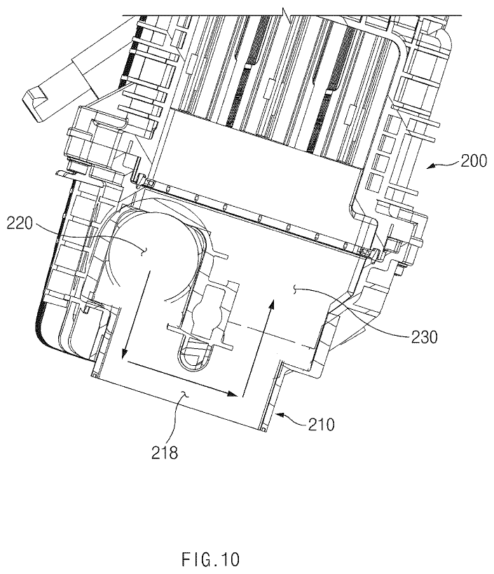

In other words, with reference to FIGS. 8 and 10, in the state in which the first valve disc 320 and the second valve disc 330 are disposed at the first position, the bypass flow path 218 may be opened. The air introduced into the first humidifier port 220 may thus flow to the second humidifier port 230 along the bypass flow path 218.

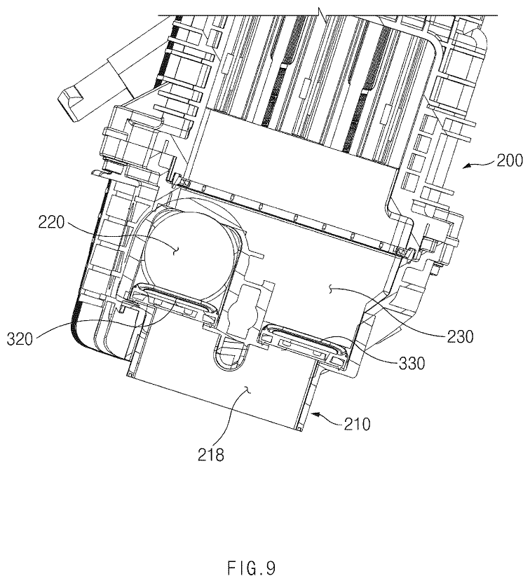

In contrast, with reference to FIGS. 8 and 9, when the first valve disc 320 and the second valve disc 330 rotate to the second position (rotate counterclockwise), the bypass flow path 218 may be closed at the same time when the first valve port 312 and the second valve port 314 are opened.

As described above, in an embodiment of the present disclosure, the bypass flow path 218 is opened or closed by the first and second valve discs 320 and 330 configured to open or close the first and second valve ports 312 and 314. Thus, a separate opening/closing member for opening or closing the bypass flow path 218 need not be additionally provided. Therefore, it is possible to obtain advantageous effects of simplifying the structure and improving the spatial utilization and degree of design freedom.

In an embodiment of the present disclosure illustrated and described above, an example has been described in which the bypass flow path 218 is closed when the first and second valve ports 312 and 314 are opened and in which the bypass flow path 218 is opened when the first and second valve ports 312 and 314 are closed. However, according to another embodiment of the present disclosure, a configuration may be made in which the bypass flow path 218 is opened at the same time when the first and second valve ports 312 and 314 are opened by adjusting the opening angles of the first and second valve discs 320 and 330 (e.g., the first valve disc rotates 20 degrees or 40 degrees from the first position). For reference, a flow rate of the air flowing through the bypass flow path 218 may increase as the opening angles of the first and second valve discs 320 and 330 decrease.

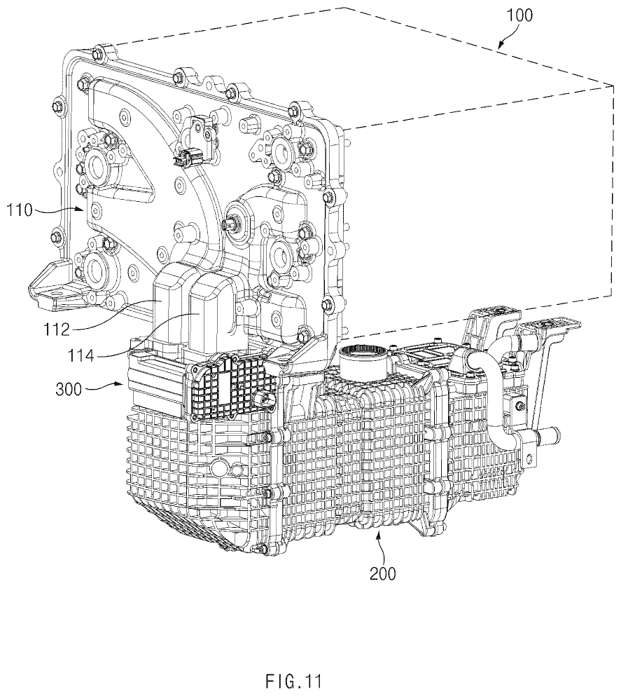

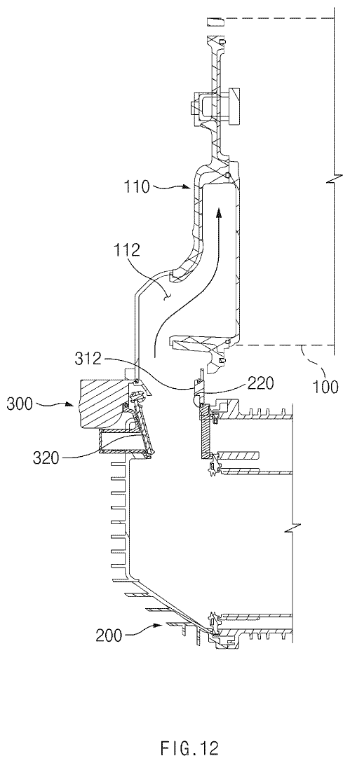

With reference to FIGS. 11 and 12, according to an embodiment of the present disclosure, the fuel cell system 10 may include a manifold block 110 provided at an end of the fuel cell stack 100, i.e., an end based on a direction in which fuel cells are stacked. The manifold block 110 may have a first manifold flow path 112 corresponding to the first valve port 312 and a second manifold flow path 114 corresponding to the second valve port 314. The air control valve 300 may be connected to the manifold block 110 and communicate with the first manifold flow path 112 and the second manifold flow path 114.

The manifold block 110 may have various structures capable of having the first manifold flow path 112 and the second manifold flow path 114 that may communicate with the flow path of the fuel cell stack 100. The present disclosure is not restricted or limited by the structure and shape of the manifold block 110.

In addition, the first manifold flow path 112 and the second manifold flow path 114 may have various structures and shapes in accordance with required conditions and design specifications. The present disclosure is not restricted or limited by the structures and shapes of the first manifold flow path 112 and the second manifold flow path 114.

In particular, the first and second manifold flow paths 112 and 114 may each be defined to have a straight section in the upward/downward direction. The air control valve 300 may be connected to the end of the first manifold flow path 112 and the end of the second manifold flow path 114 based on the upward/downward direction.

As described above, in an embodiment of the present disclosure, the air control valve 300 is connected to the ends of the first and second manifold flow paths 112 and 114 defined to have the straight sections in the upward/downward direction. Thus, the first valve port 312 and the first manifold flow path 112 may be connected in a continuous straight shape without being bent, and the second valve port 314 and the second manifold flow path 114 may be connected in a continuous straight shape without being bent. Therefore, it is possible to implement a smaller thickness of the manifold block 110 in the longitudinal direction of the humidifier 200, i.e., the direction in which the fuel cells are stacked.

In other words, the end of the manifold flow path may be formed in the horizontal direction, i.e., the longitudinal direction of the humidifier, instead of the upward/downward direction and the air control valve may be connected to the lateral side of the manifold block. However, in this case, there is a problem in that the number of curved portions (bent portions) of the manifold flow path, which connects the valve port and the fuel cell stack, is inevitably increased. In addition, the thickness of the manifold block needs to be inevitably increased in the horizontal direction, i.e., the longitudinal direction of the humidifier, in order to form a gentle curvature of the curved portion of the manifold flow path, which degrades the spatial utilization and degree of design freedom.

In contrast, in an embodiment of the present disclosure, the air control valve 300 is connected to the ends of the manifold flow paths (e.g., the first manifold flow path and the second manifold flow path) based on the upward/downward direction. Therefore, it is possible to reduce the number of curved portions of the manifold flow path, and particularly, a connection portion between the valve port and the manifold flow path is not bent. It is also possible to form an overall gentle curvature of the manifold flow path without increasing the thickness of the manifold block 110.

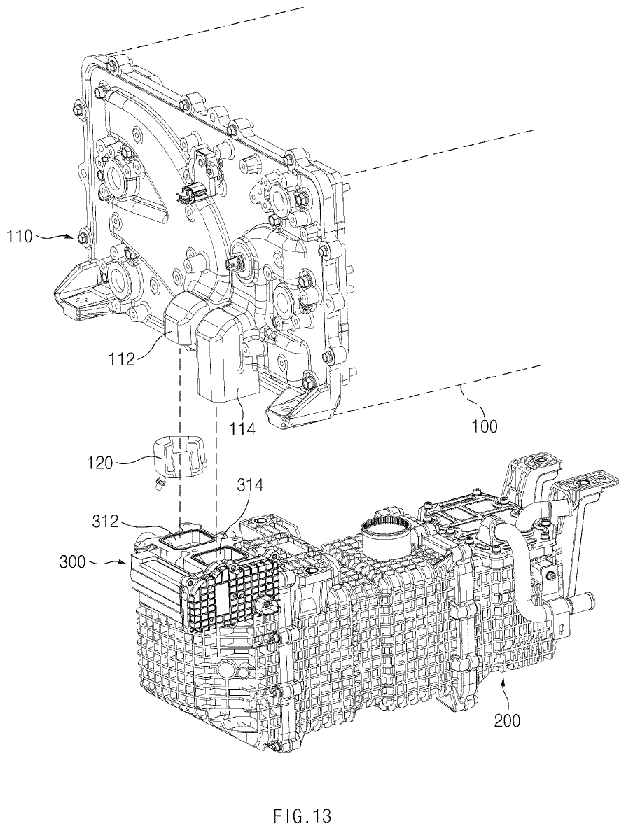

With reference to FIG. 13, according to an embodiment of the present disclosure, the fuel cell system 10 may include a gas-liquid separator 120 provided between the first valve port 312 and the first manifold flow path 112.

The gas-liquid separator 120 is configured to remove or separate droplets from the air to be supplied to the fuel cell stack 100.

For reference, the gas-liquid separator 120 needs to be installed in a straight section instead of a curved section to implement sufficient gas-liquid separation performance.

As described above, according to an embodiment of the present disclosure, the first and second manifold flow paths 112 and 114 are defined to have the straight sections in the upward/downward direction. Also, the first valve port 312 and the first manifold flow path 112 are connected in a continuous straight shape without being bent. Therefore, the sufficient straight section may be ensured between the first humidifier port 220 of the humidifier 200 and the flow path of the fuel cell stack 100. Thus, the gas-liquid separator 120 provided between the first valve port 312 and the first manifold flow path 112 may have sufficient gas-liquid separation performance.

Various separators capable of separating droplets from air may be used as the gas-liquid separator 120. The present disclosure is not restricted or limited by the type and structure of the gas-liquid separator 120.

For example, a typical baffle-type gas-liquid separator 120, a cyclonic gas-liquid separator 120, or the like may be used as the gas-liquid separator 120.

According to an embodiment of the present disclosure as described above, it is possible to obtain advantageous effects of simplifying the structure and improving the degree of design freedom and spatial utilization.

In particular, according to an embodiment of the present disclosure, it is possible to obtain advantageous effects of simplifying the structure for connecting the air control valve and the humidifier and minimizing the space between the fuel cell stack and the humidifier.

Among other things, according to an embodiment of the present disclosure, it is possible to connect the air control valve directly to the humidifier without using a separate tube for connecting the air control valve and the humidifier.

In addition, according to an embodiment of the present disclosure, it is possible to obtain advantageous effects of simplifying the manufacturing process and reducing the costs.

In addition, according to an embodiment of the present disclosure, it is possible to obtain advantageous effects of minimizing deterioration in energy efficiency caused by an increase in differential pressure in the humidifier and improving the performance and operational efficiency of the fuel cell stack.

While embodiments have been described above, the embodiments are illustrative and not intended to limit the present disclosure. It can be appreciated by those of ordinary skill in the art that various modifications and applications, which are not described above, may be made to the described embodiments without departing from the intrinsic features of the present disclosure. For example, the respective constituent elements specifically described in the embodiments may be modified and then carried out. Further, it should be interpreted that the differences related to the modifications and applications are included in the scope of the present disclosure defined by the appended claims.

What is claimed is:

1. A fuel cell system comprising:
a fuel cell stack;
a humidifier configured to humidify air to be supplied to the fuel cell stack; and
an air control valve having one end connected to the fuel cell stack and another end connected directly to the humidifier, wherein the air control valve is configured to control air that enters or exits the fuel cell stack.

2. The fuel cell system of claim 1, wherein the humidifier comprises:
a humidifier housing having a humidification part;
a first humidifier port provided at one end of the humidifier housing and configured to allow the air having passed through the humidification part to be discharged through the first humidifier port; and
a second humidifier port provided in the humidifier housing, disposed adjacent to the first humidifier port, and configured to allow moist air discharged from the fuel cell stack to enter the second humidifier port,
wherein the air control valve is seated on the humidifier housing and connected directly to the first humidifier port and the second humidifier port.

3. The fuel cell system of claim 2, wherein the humidifier housing comprises:
a first space configured to accommodate the humidification part and communicate with the first humidifier port; and
a second space separated from the first space and configured to communicate with the second humidifier port.

4. The fuel cell system of claim 2, wherein the air control valve comprises:
a valve housing having a first valve port corresponding to the first humidifier port and a second valve port corresponding to the second humidifier port;
a first valve disc configured to selectively open or close the first valve port; and
a second valve disc configured to selectively open or close the second valve port.

5. The fuel cell system of claim 4, comprising:
a rotary shaft rotatably provided on the valve housing,
wherein the first and second valve discs are configured to rotate about the rotary shaft from a first position at which the first and second valve discs close the first and second valve ports to a second position at which the first and second valve discs open the first and second valve ports.

6. The fuel cell system of claim 5, comprising:
a bypass flow path provided in the humidifier housing and configured to connect the first humidifier port and the second humidifier port so that the first humidifier port and the second humidifier port communicate with each other,
wherein the bypass flow path is configured to allow the air introduced into the first humidifier port to selectively flow to the second humidifier port.

7. The fuel cell system of claim 6, wherein inlet and outlet ends of the bypass flow path are connected to and communicate with lateral sides of the first and second humidifier ports, respectively, based on a longitudinal direction of the humidifier housing.

8. The fuel cell system of claim 6, wherein the bypass flow path is closed by the first and second valve discs when the first and second valve discs rotate from the first position to the second position.

9. The fuel cell system of claim 4, comprising:
a manifold block provided at an end of the fuel cell stack, the manifold block having a first manifold flow path corresponding to the first valve port and a second manifold flow path corresponding to the second valve port,
wherein the air control valve is connected to the manifold block and communicates with the first manifold flow path and the second manifold flow path.

10. The fuel cell system of claim 9, wherein the first and second manifold flow paths are defined to have straight sections in an upward/downward direction, and wherein the air control valve is connected to an end of the first manifold flow path and an end of the second manifold flow path based on the upward/downward direction.

11. The fuel cell system of claim 9, comprising:
a gas-liquid separator provided between the first valve port and the first manifold flow path.

12. The fuel cell system of claim 2, wherein the humidifier housing comprises:
a housing main body configured to accommodate the humidification part therein;
a first housing cap connected to one end of the housing main body; and
a second housing cap connected to the other end of the housing main body and having the first humidifier port and the second humidifier port.

13. The fuel cell system of claim 2, wherein the first and second humidifier ports are defined in a direction perpendicular to a longitudinal direction of the humidifier housing.
